(19) United States
(12) Patent Application Publication
(10) Pub. No.: US 2025/0031783 A1
(43) Pub. Date: Jan. 30, 2025

(54) FACE MASK WITH METAL MESH INSERT

(71) Applicant: Ishikawa Wire Netting Co., Ltd., Tokyo (JP)

(72) Inventor: Yukio Ishikawa, Tokyo (JP)

(73) Assignee: Ishikawa Wire Netting Co., Ltd., Tokyo (JP)

(21) Appl. No.: 18/704,703

(22) PCT Filed: Nov. 14, 2022
(86) PCT No.: PCT/JP2022/042282

§ 371 Date: Apr. 25, 2024

(30) Foreign Application Priority Data
Nov. 15, 2021 (JP) 2021-185786

(51) Int. Cl. A41D 13/11

(52) U.S. Cl. CPC A41D 13/1192

(57) ABSTRACT

Provided is a face mask with metal mesh insert (1) that includes a face mask body (2) structured to cover a human mouth and around; a mask cord (3) provided to each of both lateral sides of the face mask body (2); and an antibacterial metal mesh component (4) attachable to the face mask body. The face mask body (2) has a pocket (5) into which the metal mesh component (4) is enclosed. The pocket (5) has a side-opened opening (5b), through which the metal mesh component (4) can be inserted or taken out. The side-opened opening (5b) is likely to close when the face mask with metal mesh insert (1) is worn by a human.

### TECHNICAL FIELD

This invention relates to a face mask with metal mesh insert.

### BACKGROUND ART

Recent global pandemic of new coronavirus has raised awareness of viral infection, and various types of face mask have been used for suppressing scattering of saliva, and for preventing body fluid including saliva from adhering to facial mucosa.

For example, Patent Literature 1 discloses a pocketed nonwoven mask, which is used by inserting a copper mesh sheet in a pocket and then zipping the pocket, in expectation of antibacterial and antiviral effects.

### CITATION LIST

### Patent Literature

[Patent Literature 1] JP 3230247 Y

### SUMMARY OF THE INVENTION

### Technical Problem

The face mask disclosed in Patent Literature 1, with use of the copper mesh sheet inserted into or taken out of the top-opened pocket, was however likely to loosen the opening edge placed at the top of the face mask, due to interference between the top of the face mask and the nose. This has occasionally caused the air directly coming into the nasal cavity and mouth, without being routed through the copper mesh sheet.

There is therefore the room for improvement regarding enhancement of the antibacterial and antiviral effects.

This invention was arrived at after considering the aforementioned problems. It is therefore an object of this invention to provide a face mask with metal mesh insert, from which advanced antibacterial and antiviral effects are expectable.

### Solution to Problem

A face mask with metal mesh insert of this invention specifically includes: a face mask body structured to cover a human mouth and around; a mask cord provided to each of both lateral sides of the face mask body; and an antibacterial metal mesh component attachable to the face mask body. The face mask body has a pocket into which the metal mesh component is enclosed, and the pocket has a side-opened opening, through which the metal mesh component can be inserted or taken out.

### Advantageous Effects of Invention

This invention can provide a face mask with metal mesh insert, from which advanced antibacterial and antiviral effects are expectable.

### BRIEF DESCRIPTION OF DRAWINGS

FIG. 1 is a front elevation illustrating a face mask with metal mesh insert according to an embodiment.

FIG. 2 is a rear elevation illustrating the face mask with metal mesh insert.

FIG. 3 is a drawing illustrating a front cloth piece of the face mask body.

FIG. 4 is a drawing illustrating a backing cloth piece of the mask body.

FIG. 5 is a drawing illustrating an inner face of the backing cloth.

FIG. 6 is a drawing illustrating a cover.

FIG. 7 is a drawing illustrating one piece of metal mesh.

FIG. 8 is a side elevation illustrating a metal mesh component.

### DESCRIPTION OF EMBODIMENTS

Embodiments of this invention will be explained below referring to the attached drawings. Note that all similar constituents in all drawings will have the same reference signs to properly skip the explanation as appropriate.

Also note that the drawings referred to in the embodiments merely illustrate the structure, geometry, and arrangement of the individual pieces that compose the face mask with metal mesh insert of this invention, without limiting this invention.

The drawings do not always exactly depict dimensional proportions including length, width and height of the face mask with metal mesh insert.

### <Overview>

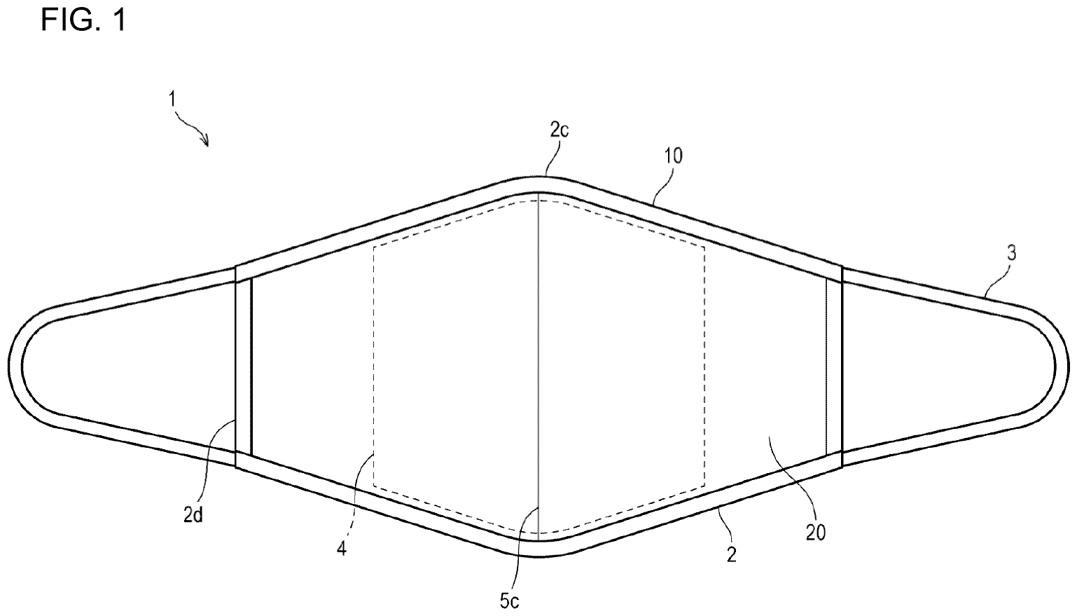

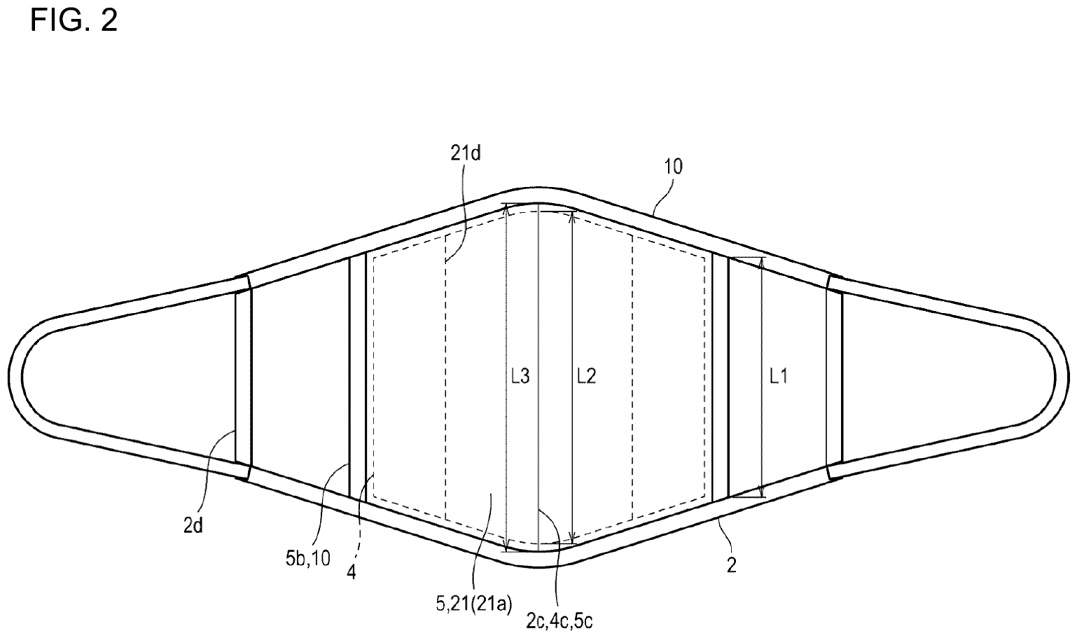

First, an overview of a face mask with metal mesh insert 1 according to an embodiment will be described, mainly referring to FIGS. 1 and 2. FIG. 1 is a front elevation of the face mask with metal mesh insert 1 of this embodiment, and FIG. 2 is a rear elevation illustrating the face mask with metal mesh insert 1.

The face mask with metal mesh insert 1 of this embodiment has a face mask body 2 structured to cover a human mouth and around; a mask cord 3 provided to each of both lateral sides of the face mask body 2; and an antibacterial metal mesh component 4 attachable to the face mask body 2.

The face mask body 2 has, as illustrated in FIG. 2, a pocket 5 into which the metal mesh component 4 is enclosed. The pocket 5 has a side-opened opening 5b, through which the metal mesh component 4 can be inserted or taken out.

The face mask body 2 includes those made of fabric, non-woven fabric, urethane or the like.

The “face mask body 2 structured to cover a human mouth and around” means that the mask covers at least a human mouth and around, and such mask of course includes those having a size large enough to cover the nose tip and around. The following description of the face mask with metal mesh insert 1 of this embodiment will be made on a face mask having a size large enough to cover the nose tip.

A metal mesh 40 that constitute “the antibacterial metal mesh component 4”, although described later in this embodiment as a mesh made of copper, is not limited to this structure, or rather, the metal mesh 40 may alternatively be made of materials such as silver, zinc, cobalt, nickel, titanium and any alloy thereof. For example, copper alloy usable herein includes brass (copper-zinc alloy), red brass, phosphor bronze, cupronickel and gold-copper alloy.

The “opening 5b” in the face body 2 of this embodiment, although described below as being side-opened, and as a pair of pieces provided on both sides of a center part 5c, may alternatively be provided only on one side of the center part 5c.

With this structure that enables the metal mesh component 4 to be enclosed from the side, the face mask with metal mesh insert 1, when worn, can more easily keep the opening 5b closed, since the face mask body 2 is tensed by the mask cords 3 which are hooked on the ears, and the nose. Hence, the face mask with metal mesh insert 1 can limit the air possibly routed through the opening 5b, thus becoming more likely to prevent the human from breathing the air that did not pass the metal mesh component 4.

### <Face Mask Body>

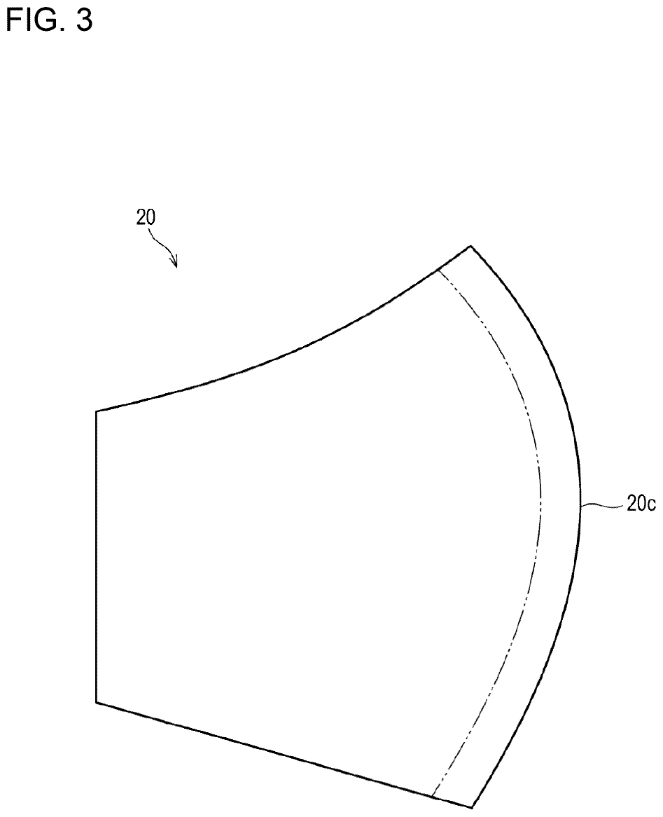

Next, the face mask body 2 will be explained, mainly referring to FIGS. 3 to 5, in addition to FIGS. 1 and 2.

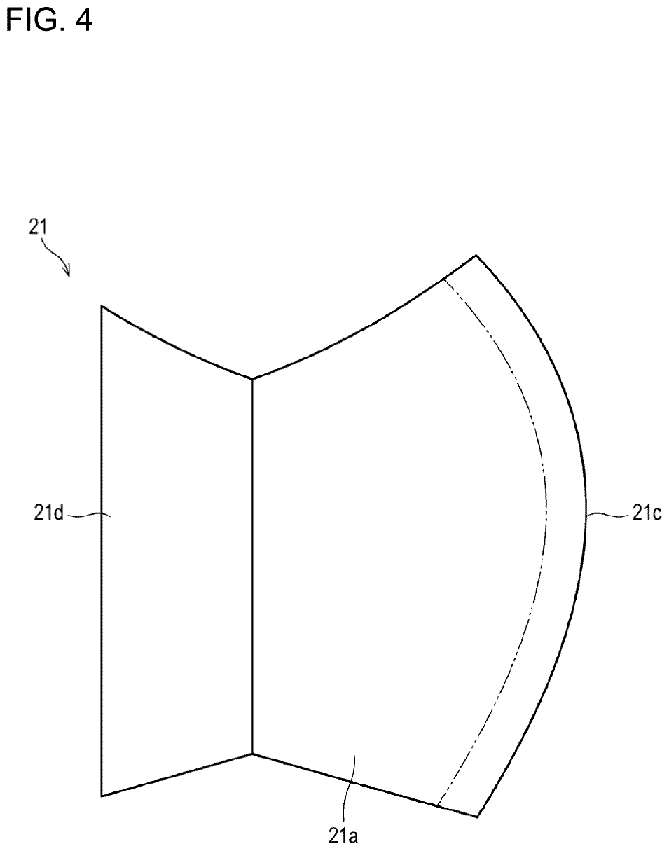

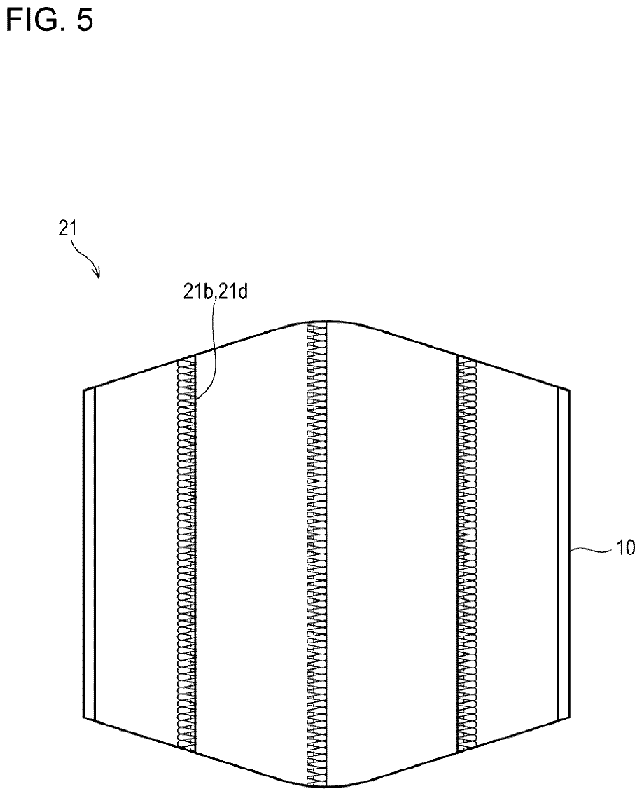

FIG. 3 is a drawing illustrating a piece of a front cloth 20 of the face mask body 2, FIG. 4 is a drawing illustrating a piece of a backing cloth 21 of the face mask body 2, and FIG. 5 is a drawing illustrating the inner face of the backing cloth 21.

The face mask body 2 is a component that covers a human mouth or around as described previously. As illustrated in FIG. 1. the face mask body 2 has a vertical length which is longer in the center part 5_{c} than at both lateral ends 2d.

The face mask body 2 is constituted by two pieces of cloth (front cloth 20 and backing cloth 21) arranged front and back while forming the pocket 5 in between.

The front cloth 20 is constituted by one piece formed in a near-fan shape as illustrated in FIG. 3, and the other piece formed in plane symmetry therewith. Arcaded parts (a seam allowance 20c, which is an area between a two-dot chain line and the edge in FIG. 3) of these components (one piece and the other piece) are mutually overlapped and sewed, whereby the front cloth 20 constitutes the front side of the face mask body 2.

The backing cloth 21 is constituted by one piece having a near-fan shape part (body 21a) and a near-trapezoidal part (foldback part 21d) formed integrally as illustrated in FIG. 4, and the other piece formed in plane symmetry therewith. The upper and lower edges of the near-trapezoidal parts. and segments of the upper and lower edges of the near-fan shaped pieces are overlapped and sewed, whereby the later-described foldback part 21d is formed.

Also arcaded parts (a seam allowance 21c, which is an area between a two-dot chain line and the edge in FIG. 4) of these components (one piece and the other piece) are mutually overlapped and sewed. The upper and lower edges are also sewed on the front cloth 20 so as to direct the foldback part 21d inwards (towards the front cloth 20), whereby the backing cloth 21 constitutes the back side of the face mask body 2.

### [Opening]

As illustrated in FIG. 2, the opening 5b is formed while retracted from both lateral ends 2d of the face mask body 2 (front cloth 20) towards the center.

Each opening 5b provided on both lateral sides in this embodiment is arranged approximately 2 cm to 3 cm away from the lateral ends 2d of the front cloth 20 towards the center. The opening Sb in this embodiment is, as illustrated in FIG. 2, provided on the back side of the face mask body 2. Since thus structured, the opening is prevented from being exposed to the outside, and can advantageously prevent the air from entering from the outside. The opening in this invention is, however, not limited to this structure, instead allowing provision on the front side (face side) of the face mask body 2.

In this structure with the opening 5b formed while retracted from both lateral ends 2d towards the center, the opening 5b is more likely to have a long vertical length, since the cloth of the face mask body 2 where the opening 5b is formed will have longer vertical length in the face mask body 2, and this makes the metal mesh component 4 more easily insertable through the opening 5b.

Since the length measured from the opening 5b to the center part 5c of the face mask body 2 is thus set shorter than in a case where the opening 5b were provided at the lateral end 2d, the metal mesh component 4 to be laid across the center part 5c will be more easily enclosed in the pocket 5.

As illustrated in FIG. 2, the metal mesh component 4 has a vertical size L2 at the center part 4c, which is larger than a vertical size L1 of the opening 5b. and is smaller than a vertical size L3 of the center part 5c of the pocket 5.

In this structure, the metal mesh component 4, even if shifted laterally from a state just enclosed in the face mask body 2, will be unlikely to accidentally drop off from the face mask body 2, since the center part 4c of the metal mesh component 4 is less likely to pass through the opening 5b.

As illustrated in FIG. 2, the backing cloth 21 has a lateral width (length measured between the lateral edges of the openings 5b), smaller than a lateral width of the front cloth 20 (length measured between the lateral ends 2d of the face mask body 2). The openings 5b are formed while retracted from the lateral ends 2d of the front cloth 20 towards the center.

With the structure having the openings 5b formed while retracted from the lateral ends 2d of the front cloth 20 towards the center, the face mask with metal mesh insert 1, when worn by the user, can close the openings 5b between the front cloth 20 and the surface of the user's face.

This successfully prevents the outer air from entering the human body. through the openings 5b without being routed through the metal mesh component 4.

### [Foldback Part]

As illustrated in FIGS. 2, 4 and 5. the pocket 5 has formed therein a catch part (foldback part 21d) provided near each opening 5b, so as to protrude towards the center in the width direction of the face mask body 2, and to catch the metal mesh component 4.

Each foldback part 21d is provided so as to overlap the metal mesh component 4 in the width direction of the face mask with metal mesh insert 1, in a state the center part in the width direction of the metal mesh component 4 is aligned with the center part 2c in the width direction of the face mask body 2.

The catch part (foldback part 21d) is formed by folding back an end portion of the backing cloth 21 towards the center. In this embodiment, the end portion of the backing cloth 21 is folded back approximately 2 cm, to form the foldback part 21d.

With the catch part (foldback part 21d) thus provided, the metal mesh component 4 can be suppressed from causing displacement within the pocket 5.

The “catch part” in this embodiment is, as illustrated in FIG. 5, the foldback part 21d provided inside the pocket 5 (a part where the front cloth 20 and the backing cloth 21 overlap).

This structure, having the catch part (foldback part 21d) formed with use of the cloth (backing cloth 21) that composes the face mask body 2, can therefore reduce uncomfortableness possibly felt by the user who wears the face mask with metal mesh insert 1.

The “catch part” is, however, not limited to have this structure, and may be provided to the front cloth 20, or even may be other than the foldback part provided to the cloth. That is, the “catch part” will suffice to catch the metal mesh component 4 enclosed in the pocket 5, so that the metal mesh component 4 may be prevented from causing displacement within the pocket 5, and may be an unillustrated hook made of a metal material or resin material, other than the foldback part 21d.

The catch part (foldback part 21d) in this embodiment is formed by folding back the end portion of the backing cloth 21 towards the center.

More specifically, the end portion of the backing cloth 21, kept folded to the inner side (front side) towards the center, is sewed together with a bias tape 10 attached to the edge of the opening 5b, which corresponds to the mountain fold of the end portion. The foldback part 21d is thus formed by holding the folded state by sewing.

In this structure, the catch part that catches the metal mesh component 4 may be formed with use of the backing cloth 21, without increasing the number of components. Note the use of the bias tape 10 is optional.

As illustrated in in FIG. 5, the catch part (foldback part 21d) has a near-the-center edge 21b overlocked. Overlocking is a method of sewing that prevents fraying of cloth, by which a sewing thread is laid across an edge (near-the-center edge 21b) front and back.

The overlocking is exemplified by twin-needle overlocking.

The foldback part 21d in this structure, having the near-the-center edge 21b overlocked, may be prevented from fraying due to catching of (contact with) the metal mesh component 4.

### <Metal Mesh Component>

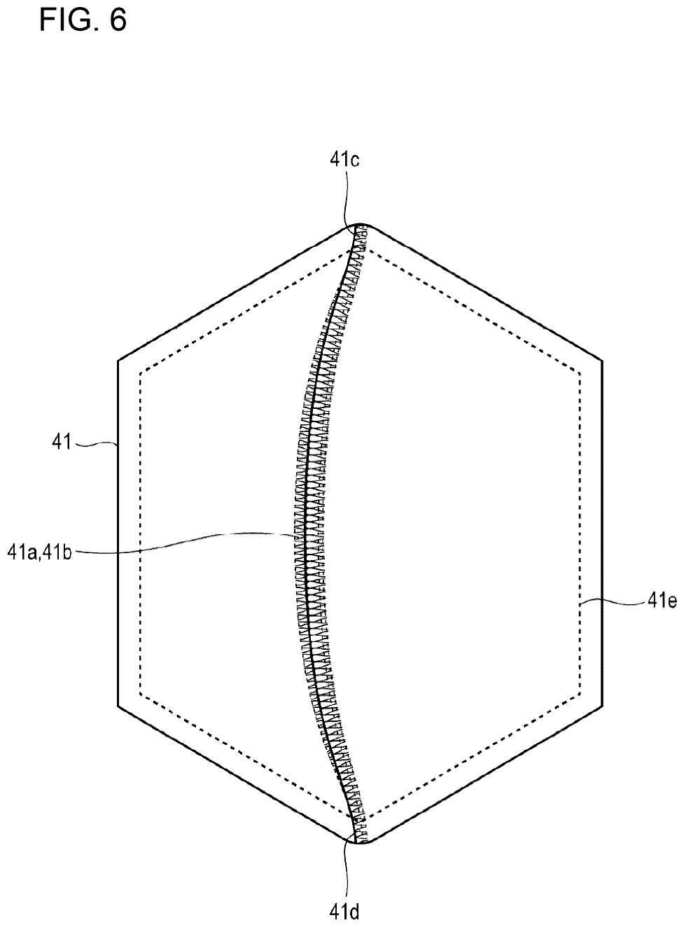

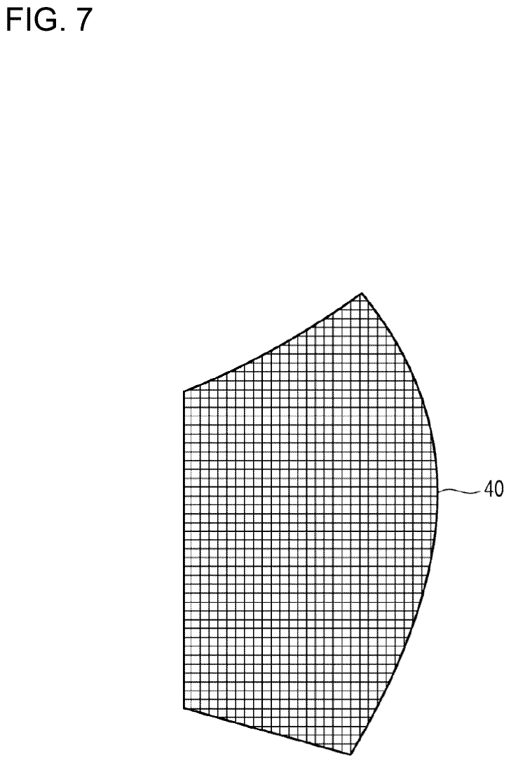

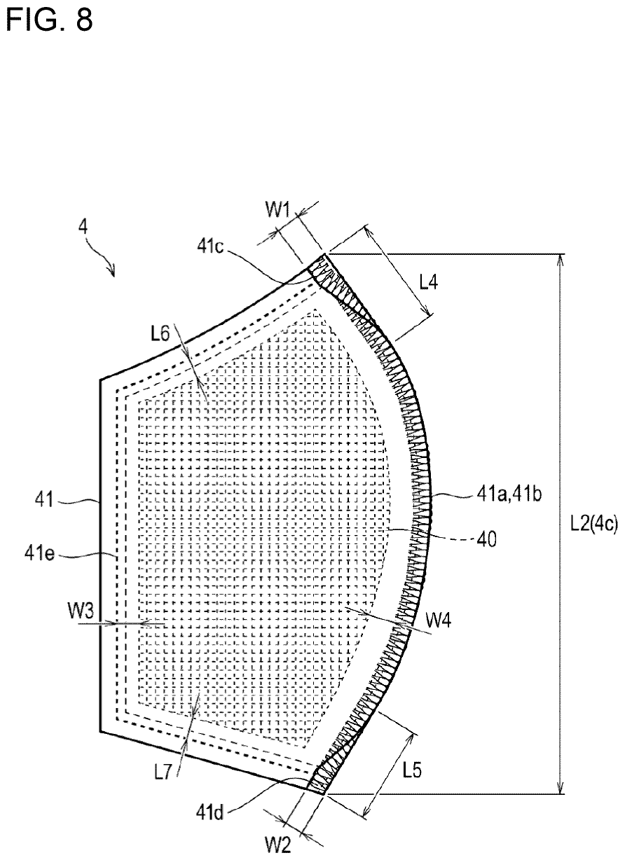

Next, the metal mesh component 4 will be explained, mainly referring to FIGS. 6 to 8. FIG. 6 is a drawing illustrating a cover 41, FIG. 7 is a drawing illustrating one piece of the metal mesh 40, and FIG. 8 is a side elevation illustrating the metal mesh component 4.

In the metal mesh component 4, the vertical length of the center part 4c is denoted as L2, the length of an upper folded part 41c as L4, the length of a lower folded part 41d as L5, the length of an upper gap between a stitch 41e and the metal mesh 40 as L6, and the length of a lower gap as L7.

Also, the width (length of a folded end) of the upper folded part 41c is denoted as W1, and width (length of a folded end) of the lower folded part 41d as W2. Also, the width of a gap between the stitch 41e and the outer end in the width direction of the metal mesh 40 is denoted as W3, and the width of a gap between the stitch 41e and the near-the-center end in the width direction of the metal mesh 40 as W4.

The metal mesh component 4 is enclosed in the pocket 5 of the face mask body 2, in expectation of providing antibacterial and antiviral performance to the face mask with metal mesh insert 1.

As illustrated in FIGS. 6 to 8, the metal mesh component 4 has the metal mesh 40 and the cloth cover 41 that encloses the metal mesh 40. The metal mesh 40 is provided as a pair of left and right pieces, one of them being illustrated in FIG. 7, and the other being plane symmetry therewith. The cover 41 is provided as a pair of left and right pieces, which are sewed integrally.

The metal mesh 40 has a sheet form, and is a mesh-like fabric formed of warp and weft made of metal wire. The metal mesh 40 preferably has a number of meshes of 100 or larger and 250 or smaller.

The diameter of each metal wire is 0.03 mm or larger and 0.09 mm or smaller on average.

The metal mesh 40 may have the warp and the weft made of the same metal, or made of different metals whose major components are different.

The metal mesh 40 may have any weaving pattern without limitation, and may be selectable from fabrics woven with use of the warp and weft by a variety of weaving patterns including plain weave, twill weave, dutch weave and twilled dutch weave.

The metal material composing the metal mesh 40 has a Young's modulus of 60 GPa or larger and 220 GPa or smaller, and preferably 100 GPa or larger and 220 GPa or smaller.

The metal material used for the metal mesh 40 may be intact, or may be surface-coated.

The cover 41 has a sewed part 41a formed along at least one side of the metal mesh 40. More specifically, the sewed part 41a is provided so as to extend vertically between the paired pieces of the metal mesh component 4.

The sewed part 41a is provided to an overlapped part 41b in which partial areas of the cover 41 are overlapped. As illustrated in FIG. 8, the overlapped part 41b and the sewed part 41a protrude out of the metal mesh 40. The overlapped part 41b has, at the upper end thereof, the upper folded part 41c which is folded and sewed on a peripheral part. In other words, the upper folded part 41c is a part of the upper end of the sewed part 41a, which is folded and sewed on the peripheral part.

The overlapped part 41b and the sewed part 41a, mentioned above with a phrase of “protrude out of the metal mesh 40”, specifically protrude ahead of the metal mesh 40 (or alternatively behind the metal mesh 40).

With this structure having the upper folded part 41c that shortens the length in the width direction (the direction that lies between both sides) as compared with the peripheral part, the face mask with metal mesh insert 1 can deform the upper folded part 41c downwards when the face mask body 2 is tensed to both sides for wearing.

The upper folded part 41c (a part to be contacted with the nose) of the face mask with metal mesh insert 1 may therefore be deformed so as to trace the face line (nose line) of the wearer of the mask with metal mesh 1.

The structure enables the cover to three-dimensionally bend so as to trace the face line.

The face mask with metal mesh insert 1 has, at the lower end of the overlapped part 41b, the lower folded part 41d which is folded upwards (obliquely upwards) and sewed on the peripheral part.

The upper folded part 41c is formed so as to be longer than the lower folded part 41d in the vertical direction.

The term “upwards” means that a upper component is contained, and conceptionally includes not only just upwards, but also obliquely upwards. Similarly, the phrase “formed so as to be longer . . . in the vertical direction” means that something is formed in a direction in which the directional component has a large value.

Given, as illustrated in FIG. 8, the length of the upper folded part 41c as L4, and the length of the lower folded part 41d as L5, now length L4 is longer than length L5, and length L4 has a value of vertical component larger than that of length L5.

Note that sewing of the upper folded part 41c and the lower folded part 41d on the peripheral parts, so as to make width W1 larger than width W2, will inevitably make length L4 larger than length L5.

The structure can achieve fitting on the chin, with the aid of such lower folded part 41d.

Moreover, with the upper folded part 41c formed longer than the lower folded part 41d in the vertical direction, the upper folded part 41c will cause an angle of deformation larger than that of the folded part 41d, when the face mask body 2 is tensed to both sides. This makes the face mask with metal mesh insert 1, provided with the metal mesh components 4, easier to wear on the nose.

As illustrated in FIG. 8, there is a gap of width W4 between the metal mesh 40 enclosed in the cover 41, and the sewed part 41a. With the gap thus provided, an unillustrated sewing machine needle is prevented from being broken due to collision on the metal mesh 40 during sewing of the sewed part 41a.

Sum of the horizontal components of width W3 and width W4 is larger than sum of the vertical components of length L6 and length L7.

Now, the horizontal direction is synonymous to the width direction of the face mask with metal mesh insert 1, and the vertical direction is synonymous to the top-bottom direction of the face mask with metal mesh insert 1.

In other words, the metal mesh 40 in the cover 41 has a lateral clearance (allowable range of displacement) larger than a vertical clearance.

The face mask with metal mesh insert 1, adaptively worn on the user's face, will cause displacement in the lateral direction more largely than in the vertical direction. The aforementioned relations among widths W3, W4, and lengths L6, L7 can produce a larger clearance of the metal mesh 40 in the lateral direction, and can make the metal mesh 40 and the cover 41 more likely to relatively displace, thus smoothening wearing of the face mask with metal mesh insert 1 that contains these components.

Note the various constituents of the face mask with metal mesh insert of this invention is not always necessarily independent from each other, instead allowing for example that a plurality of constituents is integrated into a single piece, that a single constituent is composed of a plurality of pieces, that a certain constituent forms a part of other constituents, and that a certain constituent shares a part thereof with a part of other constituent.

This embodiment encompasses the technical spirits below.

(1) A face mask with metal mesh insert that includes: a face mask body structured to cover a human mouth and around:
a mask cord provided to each of both lateral sides of the face mask body; and
an antibacterial metal mesh component attachable to the face mask body,
the face mask body having a pocket into which the metal mesh component is enclosed, and
the pocket having a side-opened opening, through which the metal mesh component can be inserted or taken out.

(2) The face mask with metal mesh insert according to (1), wherein the face mask body has a vertical length which is longer in a center part than at both lateral ends, and
the opening is formed while retracted from both lateral ends of the mask body towards the center.

(3) The face mask with metal mesh insert according to (2), wherein the metal mesh component has a vertical size which is larger than a vertical size of the opening, and smaller than a vertical size of the center part of the pocket.

(4) The face mask with metal mesh insert according to any one of (1) to (3), wherein the pocket has formed therein a catch part provided near the opening, so as to protrude towards the center in a width direction of the face mask body and to catch the metal mesh component, and
the catch part is provided so as to overlap the metal mesh component in a width direction of the face mask with metal mesh insert, in a state the center part in the width direction of the metal mesh component is aligned with the center part in the width direction of the face mask body.

(5) The face mask with metal mesh insert according to (4), wherein the face mask body is constituted by two pieces of cloth arranged front and back while forming the pocket in between, and
the catch part is formed by folding back an end portion of the front cloth or the backing cloth towards the center.

(6) The face mask with metal mesh insert according to (5), wherein the backing cloth is formed with a lateral width set shorter than a lateral width of the front cloth, and
the opening is formed while retracted from both lateral ends of the front cloth towards the center.

(7) The face mask with metal mesh insert according to (6), wherein the catch part is formed by folding back the end portion of the backing cloth towards the center.

(8) The face mask with metal mesh insert according to any one of (4) to (6), wherein the catch part has a near-the-center edge overlocked.

(9) The face mask with metal mesh insert according to any one of (1) to (8), wherein the metal mesh component has a metal mesh and a cloth cover that encloses the metal mesh,
the cover has a sewed part formed along at least one side of the metal mesh,
the sewed part is provided to an overlapped part in which partial areas of the covers are overlapped,
the overlapped part and the sewed part protrude out of the metal mesh, and
the overlapped part has, at an upper end thereof, an upper folded part which is folded and sewed on a peripheral part.

(10) The face mask with metal mesh insert according to any one of (1) to (9), wherein the metal mesh component has a metal mesh and a cloth cover that encloses the metal mesh, and is provided as a pair of left and right pieces,
a sewed part is provided so as to extend vertically between the left and right pieces, and
an upper end of the sewed part is folded and sewed on a peripheral part.

(11) The face mask with metal mesh insert according to (9), further comprising, at an lower end of the overlapped part, a lower folded part which is folded upwards and sewed on the peripheral part, and
the upper folded part is formed so as to be longer than the lower folded part in the vertical direction.

This application claims priority to Japanese Patent Application No. 2021-185786 filed on Nov. 15, 2021, the entire contents of which are incorporated by reference herein.

### REFERENCE SIGNS LIST

1 face mask with metal mesh insert
2 face mask body
2c center part
2d both lateral ends
3 mask cord
4 metal mesh component
4c center part
5 pocket
5b opening
5c center part
10 bias tape
20 front cloth
20c seam allowance
21 backing cloth
21a body
21b near-the-center edge
21c seam allowance
21d foldback part (catch part)
40 metal mesh
41 cover
41a sewed part
41b overlapped part
41c upper folded part
41d lower folded part
41e stitch

1. A face mask with metal mesh insert comprising:
a face mask body structured to cover a human mouth and around;
a mask cord provided to each of both lateral sides of the face mask body; and
an antibacterial metal mesh component attachable to the face mask body,
the face mask body having a pocket into which the metal mesh component is enclosed, and
the pocket having a side-opened opening, through which the metal mesh component can be inserted or taken out.

2. The face mask with metal mesh insert according to claim 1, wherein the face mask body has a vertical length which is longer in a center part than at both lateral ends, and
the opening is formed while retracted from both lateral ends of the mask body towards the center.

3. The face mask with metal mesh insert according to claim 2, wherein the metal mesh component has a vertical size which is larger than a vertical size of the opening, and smaller than a vertical size of the center part of the pocket.

4. The face mask with metal mesh insert according to claim 1, wherein the pocket has formed therein a catch part provided near the opening, so as to protrude towards the center in a width direction of the face mask body and to catch the metal mesh component, and
the catch part is provided so as to overlap the metal mesh component in a width direction of the face mask with metal mesh insert, in a state the center part in the width direction of the metal mesh component is aligned with the center part in the width direction of the face mask body.

5. The face mask with metal mesh insert according to claim 1, wherein the face mask body is constituted by two pieces of cloth arranged front and back while forming the pocket in between,
a foldback part is formed by folding an end portion, in the width direction of the face mask with metal mesh insert, of the front cloth or the backing cloth towards the center and inwards the pocket,
the foldback part is provided so as to overlap the metal mesh component in the width direction, in a state the center part of the metal mesh component in the width direction is aligned with the center part of the face mask body in the width direction, and
the foldback part catches the metal mesh component.

6. The face mask with metal mesh insert according to claim 5, wherein the backing cloth is formed with a lateral width set shorter than a lateral width of the front cloth, and
the opening is formed while retracted from both lateral ends of the front cloth towards the center.

7. The face mask with metal mesh insert according to claim 6, wherein the catch part is formed by folding back the end portion of the backing cloth towards the center.

8. The face mask with metal mesh insert according to claim 4, wherein the catch part has a near-the-center edge overlocked.

9. The face mask with metal mesh insert according to claim 1, wherein the metal mesh component has a metal mesh and a cloth cover that encloses the metal mesh,
the cover has a sewed part formed along at least one side of the metal mesh,
the sewed part is provided to an overlapped part in which partial areas of the covers are overlapped,
the overlapped part and the sewed part protrude out of the metal mesh, and
the overlapped part has, at an upper end thereof, an upper folded part which is folded and sewed on a peripheral part.

10. The face mask with metal mesh insert according to claim 1, wherein the metal mesh component has a metal mesh and a cloth cover that encloses the metal mesh, and is provided as a pair of left and right pieces,
a sewed part is provided so as to extend vertically between the left and right pieces, and
an upper end of the sewed part is folded and sewed on a peripheral part.

11. The face mask with metal mesh insert according to claim 9, further comprising, at a lower end of the overlapped part, a lower folded part which is folded upwards and sewed on the peripheral part, and
the upper folded part is formed so as to be longer than the lower folded part in the vertical direction.
